(19) United States
(12) Patent Application Publication
(10) Pub. No.: US 2010/0228738 A1
(43) Pub. Date: Sep. 9, 2010

(54) ADAPTIVE DOCUMENT SAMPLING FOR INFORMATION EXTRACTION

(76) Inventors: Rupesh R. Mehta, Maharashtra (IN); Srinivasan H. Sengamedu, Bangalore (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/398,162

(22) Filed: Mar. 4, 2009

(51) Int. Cl. G06F 17/30; G06F 17/21

(52) U.S. Cl. 707/748; 715/273; 707/E17.008; 707/E17.014; 715/234; 707/736

(57) ABSTRACT

A method and apparatus for improved sampling documents for training sets input to information extraction systems is provided, which improves the recall and robustness of wrapper extraction. A passive sampling technique provides a list of documents to present for human annotation ordered by representativeness of the document based on structural and content statistics. Thus, the document with the most interesting attributes and which is most representative of the cluster of structurally similar documents to which the document pertains is presented for annotation first. The problem is mapped to classical ‘Set-Cover’ problem and solved using greedy approach. An active sampling technique refines and reorders the sample list produced by the passive sampling technique after initial annotations, based on the human annotation, spatial boundaries of the documents, and structural and content statistics. The proposed techniques work at a site level and perform page-level structural analysis using XPath-term frequency, XPath-document frequency, and XPath-importance.

### CROSS REFERENCE TO RELATED APPLICATIONS

This application is related to U.S. patent application Ser. No. 12/030,301, filed on Feb. 13, 2008, entitled “ADAPTIVE SAMPLING OF WEB PAGES FOR EXTRACTION”, the entire content of which is incorporated by reference for all purposes as if fully disclosed herein.

This application is related to U.S. patent application Ser. No. 12/346,483, filed on Dec. 30, 2008, entitled “APPROACHES FOR THE UNSUPERVISED CREATION OF STRUCTURAL TEMPLATES FOR ELECTRONIC DOCUMENTS”, the entire content of which is incorporated by reference for all purposes as if fully disclosed herein.

### FIELD OF THE INVENTION

The present invention relates to information extraction techniques, and more specifically, to improving the selection of a set of pages to be annotated, by a human, from a site of structurally similar pages, in order to improve the robustness and recall of information extraction learning.

### BACKGROUND

The Internet is a worldwide system of computer networks and is a public, self-sustaining facility that is accessible to tens of millions of people worldwide. The most widely used part of the Internet is the World Wide Web, often abbreviated “www” or simply referred to as just “the web”. The web is an Internet service that organizes information through the use of hypermedia. Various markup languages such as, for example, the HyperText Markup Language (“HTML”) or the “eXtensible Markup Language (“XML”), are typically used to specify the contents and format of a hypermedia document (e.g., a web page). In this context, a markup language document may be a file that contains source code for a particular web page. Typically, a markup language document includes one or more pre-defined tags with content enclosed between the tags or included as attributes of the tags.

Today, a plethora of web portals and sites are hosted on the Internet in diverse fields like e-commerce, boarding and lodging, and entertainment. The information presented by any particular web site is usually presented in a uniform format to give a uniform look and feel to the web pages therein. The uniform appeal is usually achieved by using scripts to generate the static content and structure of the web pages, and a database is used to provide the dynamic content. The information presented by such a web page is generally found at visually strategic locations on the page. Thus, extracting information from web pages requires identifying the areas on the pages where information is presented, and extracting and indexing the relevant information. Information extraction from such sites becomes important for applications, such as search engines, requiring extraction of information from a large number of web portals and sites.

In their most generic form, information extraction techniques are called wrappers or structural templates. Two non-limiting examples of information extraction techniques are rule-based extraction and statistical machine-learning extraction. In order to extract information from a particular set of structurally-related web pages, referred to as a site or cluster, a wrapper generally learns a set of extraction rules based on the structural characteristics of the web pages in the site. These structural characteristics are identified through the use of training pages, which are a subset of web pages in the subject site that are annotated by humans and then input to the wrapper. Selection of training pages is sometimes called sampling, and the training pages themselves are sometimes called samples.

Some information extraction systems select random pages for annotation, or base the selection of pages on human judgment. Samples chosen at random do not guarantee coverage of all structural variations in the cluster of related pages and may submit for human annotation redundant sample pages, incurring extra cost of human annotation. Human-based page selection is non-trivial, cumbersome, erroneous, prone to omissions, and does not guarantee the selection of appropriate samples because visually similar pages might differ in their underlying structural representation. Also, human-based sampling can be expensive because a human can spend a lot of time reviewing the pages in a cluster in order to select representative pages of the cluster.

To annotate a sample page, a human inspects the page and manually identifies areas of the page having attributes of interest. Those attributes identified by a human to be interesting are called key attributes. The wrappers use the information provided by human annotations to identify trends in the placement of certain kinds of information presented by the web pages of a site. Extraction rules are generally derived from these identified trends. Annotations are costly because of the time that must be spent in order for a human to annotate a set of training pages.

Although many web sites are script-generated, the web pages of a web site can vary in their structure because of optional, disjunctive, extraneous, or styling sections. If small but important structural variations are not annotated by a human to identify the structural variations, the wrappers may fail to extract required attributes from pages having such variations. Thus, there is a need to annotate pages in a site that are representative of the variations in structure in the pages of the site while keeping the cost of human annotation to a minimum.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a simple example HTML document;

FIG. 2 illustrates a DOM tree that represents the structure of the HTML document of FIG. 1;

FIG. 3 illustrates a second example HTML document;

FIG. 4 is a flowchart illustrating an example process for selecting pages from a site of structurally similar pages to be annotated by humans, according to the passive sampling technique of the embodiments of the invention;

FIG. 5 is a graphical representation of the HTML document in FIG. 3 generated by a typical web browser;

FIG. 6 illustrates an example web page;

FIG. 7 illustrates an example web page that has been annotated;

FIG. 8 is a flowchart illustrating an example process for selecting pages from a site of structurally similar pages to be annotated by humans, according to the active sampling technique of the embodiments of the invention;

FIG. 9 illustrates an example web page that has been annotated and divided into spatial regions;

FIGS. 10 and 11 illustrate example web pages that have been divided into spatial regions;

FIG. 12 is a flowchart illustrating an example process for annotating documents, according to the active sampling technique of the embodiments of the invention;

FIG. 13 is a flowchart illustrating an example process for selecting pages from a site of structurally similar pages to be annotated by humans, according to the active sampling technique of the embodiments of the invention; and

FIG. 14 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The recall of a wrapper, which is the ability of the wrapper to accurately extract information from all of the pages in a site, mainly depends upon the representativeness of the structure of the annotated pages in the training set input to the wrapper. For example, Site A might consist of data structures ‘a’, ‘b’, ‘c’, ‘d’, and ‘e’. If a training set input to a wrapper for Site A consists of a single annotated page representing only data structure ‘a’, then the wrapper would have a low recall because the wrapper would only be able to recognize structure ‘a’ in the rest of the pages of Site A, and would be ignorant of structures ‘b’ through ‘e’. However, if an annotated page representing structures ‘b’ through ‘e’ were added to the training set for Site A, then the wrapper would have a very high recall because the wrapper would recognize all of the structures in the pages of Site A. For a further example, Site B might contain structures ‘a’, ‘b’, and ‘c’, and also structural variations of structure ‘c’: ‘c1’, and ‘c2’. A structural variation in a site is the visual presentation of the same type of information, i.e., the information represented in structure ‘c’, using different underlying structures on different pages of the site, i.e., structures ‘c’, ‘c1’, and ‘c2’. In order to have maximum recall, pages representing structures ‘a’, ‘b’, ‘c’, ‘c1’, and ‘c2’ should be represented in the pages of the training set for Site B. Thus, it would be advantageous to increase wrapper recall by presenting to humans for annotation those pages that are most structurally representative of the cluster of pages from which information is to be extracted. The problem of choosing which pages to present to humans for annotation is called the page sampling problem.

In one embodiment of the invention, a site is a set of structurally similar pages. In another embodiment of the invention, passive sampling is used to identify, from a site, a subset of pages, which, if included in the training set of a wrapper, would maximize the recall of that wrapper. This subset of pages, identified by passive sampling, is ordered by the recall addition of the respective pages, such that the first page is the most representative page of the site. When annotated in order, each annotated page adds the maximum amount of recall to the wrapper. Thus, pages are presented for human annotation in order starting with the most structurally representative page that includes the most interesting attributes. After the most representative page, subsequent sample pages are presented that represent most of the structural variations in the site that have not yet been presented for human annotation, thus ensuring maximum recall. Once the samples required for the training set for a site have been selected using above method, or no more pages are required to represent all of the unique structures in the site, the first page is surfaced, or presented, to a human for annotation.

In another embodiment of the invention, the page sampling problem is mapped to the set-cover problem. The set-cover problem states that, given an input of several sets containing some elements in common, the goal is to select a minimum number of these sets such that the selected sets contain all of the elements that are contained in any of the sets in the input. One solution to the set-cover problem is the greedy solution where a set is selected to be part of the solution if the set contains a maximum number of elements not covered by sets already selected to be part of the solution, i.e., uncovered elements. In the context of mapping the page sampling problem to the set-cover problem, a “set” is a document in a site from which information is to be extracted, and an “element” is a structure in a document. Given that the documents in a site have some structures in common, the principles of the set-cover problem can be used to select a minimum number of sample documents from the site that cover all of the unique structures in the site, thus improving recall with minimum human annotation cost. Implementing the greedy solution in the context of the page sampling problem, a document is selected to be in the solution set if the document represents the maximum number of structures not covered by documents already in the solution set. However, unlike the classical set-cover solution, the solution set of the page sampling problem is ranked based on representativeness of the documents in the solution set such that the top documents in the solution represent most of the unique, representative structures having higher importance based on the content associated with those structures.

In another embodiment of the invention, active sampling is used to increase wrapper recall even further. In active sampling, the list of documents to be annotated is actively refined after each human input, using passive sampling techniques in conjunction with information derived from interesting attributes identified by human annotation and information gleaned from the structure of the annotated data region. Thus, redundant samples brought to light by the human annotations are eliminated from the sample list and the list is reordered based on the representativeness of the samples still in the sample list, which improves the potential recall added by subsequently annotated pages.

As such, passive sampling and active sampling can be used to optimize human annotation cost and improve the extraction recall. Passive sampling is invoked in the absence of human annotations and is expected to select a minimal, ordered, representative list of samples. Active sampling can optionally be invoked once human annotations are available for the first page in the sample list produced by passive sampling, in order to refine and reorder the sample list, based on the annotations provided.

### Passive Sampling

Passive sampling can be used to aid in selecting those pages of a site that will add maximum recall to a wrapper while using minimum human input. In one embodiment of the invention, in the absence of human annotation, web pages can be ranked based on a structural representativeness score of each page. The structures in a web page are represented by the various XPaths found in the page, and the representativeness score of a particular page is based at least in part on an analysis of the XPaths found both in the particular page, and in the other pages of the site.

### XPath

XPath is a language that describes a way to locate and process items in XML documents by using an addressing syntax based on a path through the logical structure of the document, and has been recommended by the World Wide Web Consortium (W3C). The specification for XPath can be found at http://www.w3.org/TR/XPath.HTML, and the disclosure thereof is incorporated by reference as if fully disclosed herein. Also, the W3C tutorial for XPath can be found at http://www.w3schools.com/XPath/default.asp, and the disclosure thereof is incorporated by reference as if fully disclosed herein. Herein, references to an “XPath,” or “path” refer to an attributed XPath of a leaf node, unless explicitly stated otherwise, for purposes of explanation. However, a person of ordinary skill in the art will understand that the embodiments of the invention can be implemented using XPaths of any form. In one embodiment of the invention, the definition of an attributed XPath of a particular item in a document is taken to be the set of nodes found in the path to the particular item from the root of the document's Document Object Model (DOM) tree, including the name of each node and the attribute list of each node, inclusive of the root and the particular item. The attributes in each node are ordered alphabetically in an attributed XPath.

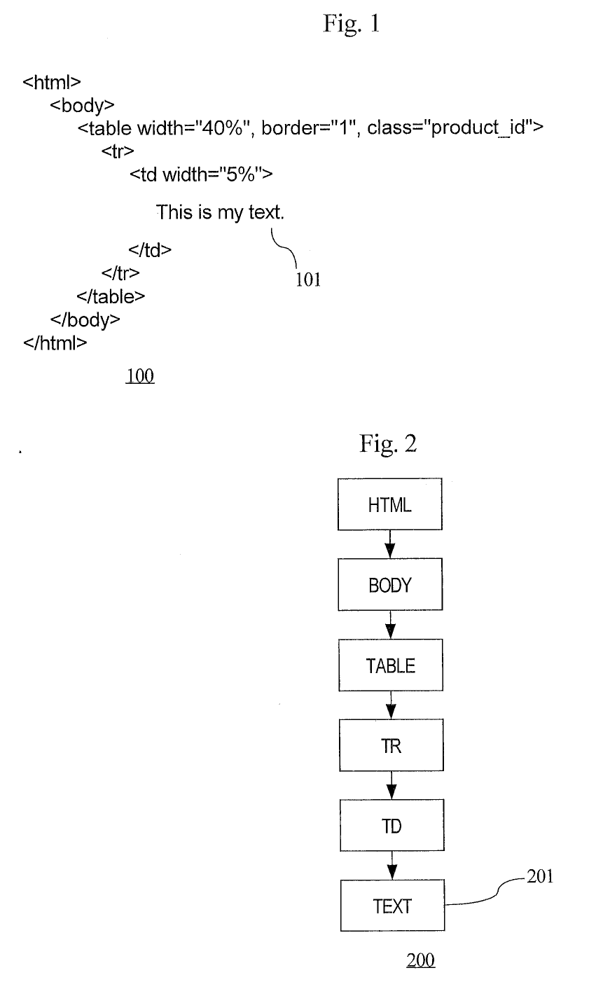

For example, FIG. 1 represents a simple HTML web page 100 having a table with a single cell containing text node 101 with the words “This is my text.” FIG. 2 shows DOM tree 200 representing web page 100. It is apparent from DOM tree 200 that the attributed path for text node 101, represented in DOM tree by node 201, is the following: /<HTML>/<body>/<table border, class, width>/<tr>/<td width>/<#TEXT>.

In another embodiment of the invention, the values of the “class” attributes of the nodes in a path are included in an attributed XPath because such class information can be used in classifying the type of the subject node. “Class” is one of the core HTML attributes and allows authors of web pages to define specific types of a given element. Thus, in this embodiment of the invention, the attributed path of text node 101 includes the value of the “class” attribute in the “table” node, as follows: /<HTML>/<body>/<table border, class=“product_id”, width>/<tr>/<td width>/<#TEXT>.

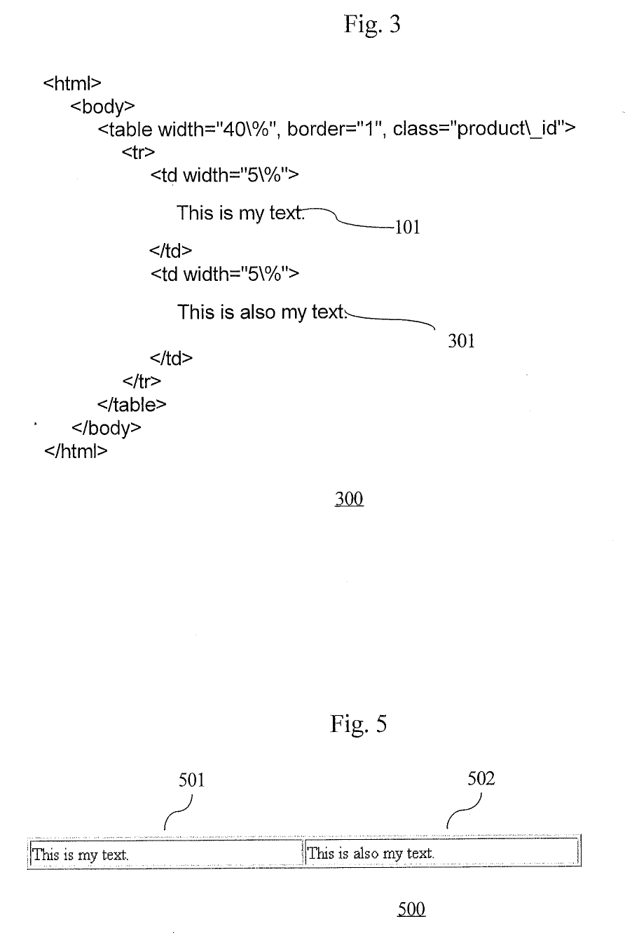

Because an attributed XPath is an unnumbered XPath, the attributed XPaths found in a particular web page are not necessarily unique. For example, FIG. 3 shows web page 300, which is similar to web page 100, except that page 300 has an additional cell in the table, which contains text node 301 with the words “This is also my text.” The attributed XPath of both text node 101 and text node 301 is /<HTML>/<body>/<table border, class=“product_id”, width>/<tr>/<td width>/<#TEXT>. Thus, there are two occurrences of the above-described attributed XPath in web page 300.

### Set-Cover Analysis of the Structure of Web Pages

As previously stated, the problem of selecting pages for a wrapper's training set can be solved using ideas from the conventional set-cover problem, which is an optimization problem that is NP-Hard and has several approximate solutions. The greedy approximate solution, implemented in one embodiment of the invention, works by selecting and annotating the most representative page of the site based on a representativeness score. The representativeness score of a page is a function of (a) the frequency that an XPath occurs in a particular page of the site, (b) the frequency that an XPath occurs among the various pages of the site, and (c) the co-occurrence of an XPath with content presented by the pages of the site. Thus, in one embodiment of the invention, the first page selected to be annotated for a training set has the highest representativeness score. Subsequently, the second most representative page is selected to be annotated based on recomputing the representativeness score for each page in the site except the first page, ignoring XPaths present in the first page, and selecting the page having highest score based on the recomputation, and so on.

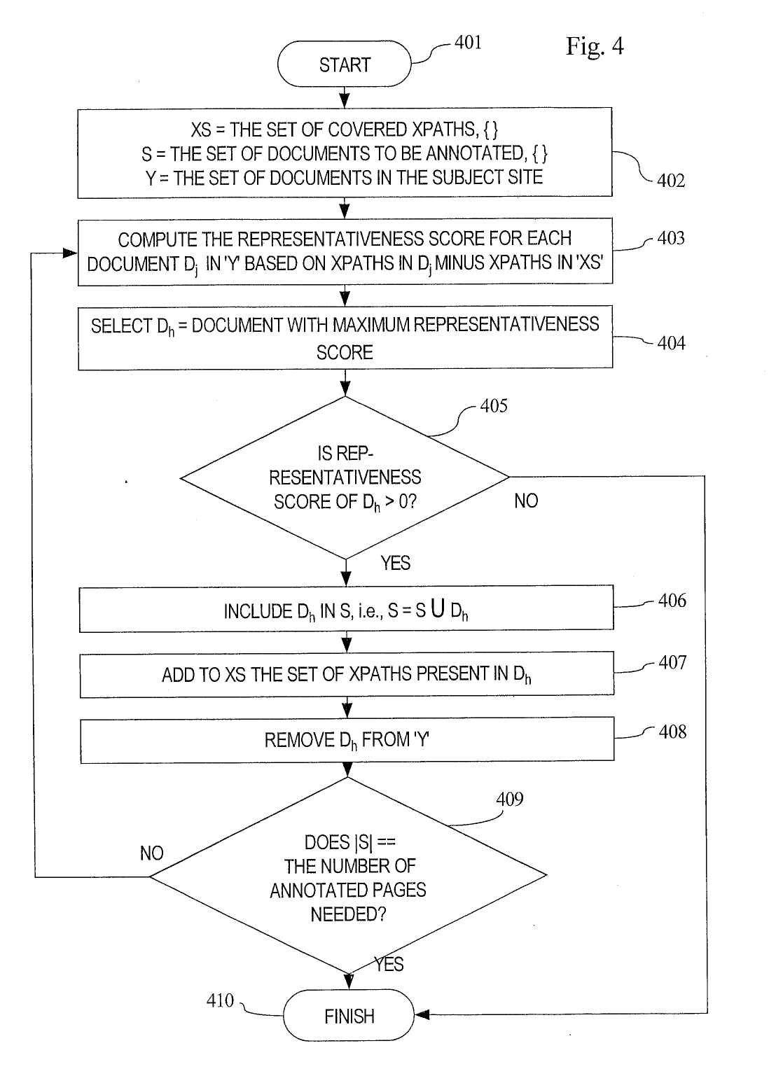

In an example process for passive sampling illustrated by FIG. 4, the set, XS, contains all unique XPaths that are present in documents selected to be annotated and is initially set to empty set, { }, step 402. The set, S, of documents to be annotated is set to the empty set, { }, because no pages have yet been selected for annotation, step 402. Also in step 402, the set, Y, is populated with those documents of the subject site that have not yet been selected to be annotated, which initially contains all of the documents of the subject site. The representativeness of each document, Dⱼ, in Y is computed, in step 403, based on the set of XPaths that are present in Dⱼ and absent in the covered XPath set, XS. A document, Dₕ, is selected with the maximum representativeness score, i.e., the highest score of all documents Dⱼ in Y, step 404. If the representativeness score of Dₕ is greater than zero, step 405, then the document is included in the set, S, of documents to be annotated, step 406. However, if the representativeness score of Dₕ is not greater than zero, then the process of selecting documents to be in the set of documents to be annotated, S, is complete, step 410, because annotation of documents with representativeness scores equal to zero would not be informative regarding the pages in the subject site. The XPaths represented in Dₕ are added to the set of covered XPaths, XS, step 407. Thus, XS represents the set of all unique XPaths that are covered by documents to be annotated. Dₕ is removed from set Y, at step 408, in order to remove document Dₕ from subsequent recalculations of representativeness scores of the documents in set Y. Then, at step 409, the process of computing representativeness scores of the remaining documents in set Y, i.e., the documents in the site not already selected for annotation, is continued if the number of documents in set S are less than the number of pages needed for the training set. If the number of pages needed for the training set, K, is known, K is assumed to be non-zero. If K is not known, then documents are selected to be a part of S until there are no unique uncovered, informative XPaths in XS. Thus, by mapping this page-sampling problem to the classical set-cover problem and implementing the greedy solution, the minimum number of pages are selected that cover all unique XPaths in the site and maximize recall of the wrapper.

### Computing a Representativeness Score

In one embodiment of the invention, the representativeness score of a page is computed based at least in part on the term frequency of each XPath for each web page in the site (XPath-TF), determining the document frequency for every XPath in the site (XPath-DF), and determining the importance of each XPath in the site (XPath-Imp).

### Term Frequency

One embodiment of the invention computes structural information in terms of XPath term frequency (XPath-TF), which is the number of times a particular XPath occurs in a particular web page of the site. In the calculation of XPath-TF denoted TF(Xᵢⱼ), the subject XPath is denoted Xᵢ, and the subject web page is denoted Pⱼ. Thus, TF(Xᵢⱼ) represents the number of times Xᵢ appears in page Pⱼ.

A high XPath-TF for an XPath in a web page will generally boost the overall representativeness score of the page because a high number of a particular XPath in a page increases the chance that the page covers most of the informative attributes associated with that XPath, and including such a page in the training set of a wrapper would increase the robustness of the wrapper learning. Furthermore, a wrapper learning process will encounter positive candidates and a variety of negative candidates for each key piece of information in a site, and a page having a higher XPath-TF might cover a majority of the negative candidates. It is beneficial to include such a web page in the training set because information on negative candidates also leads to a more robust wrapper learning. Thus, for a particular XPath, a page with a higher XPath-TF value for the particular XPath will be given preference over a page with lower XPath-TF for the particular XPath.

### Document Frequency

Another embodiment of the invention computes structural information in terms of XPath document frequency (XPath-DF). The document frequency of an XPath, Xᵢ, is denoted DF(Xᵢ), and signifies the number of pages in a particular site that contain Xᵢ. The XPath-DF of a particular XPath indicates the representativeness of the XPath itself, and a page's representativeness score is directly proportional to the representativeness of each XPath present in the page. For example, Site A might have three structural variations for the key attribute “Title” across the pages of the site. As a non-limiting example of a structural variation for a particular attribute, the pages of a site might be inconsistent with respect to the XPath at which the particular attribute is found. Thus, in the case of Site A, the attribute “Title” is associated with X₁, X₂, and X₃ on various different pages. If X₁ has the highest XPath-DF of the three variations associated with the attribute “Title,” then the pages containing X₁ should be given preference over the pages containing X₂ and X₃. This preference is because an annotation of X₁ will be informative about more pages in Site A than an annotation of X₂ or X₃. In other words, pages including X₁ will provide a higher recall than the other pages in the site with respect to the attribute “Title.” Thus, preference of pages including X₁ will aid in achieving maximum recall with minimum annotations with respect to the attribute “Title.” Outlier pages, such as a frequently asked questions page in a product page cluster, generally have very low XPath-DF and hence may get a low page representativeness score, either pushing the outlier page to the bottom of the sample list or eliminating the page.

### XPath Importance

Yet another embodiment of the invention computes structural information in terms of the importance of an XPath (XPath-Imp). Web pages are structured to contain not only informative content like product information in a shopping domain, or job information in a job domain, but also content like navigation panels and copyright information. A navigation panel and other such content is considered to be mere noise from an information extraction point of view because the information presented by a navigation panel is presented for the purpose of navigating though pages of the site, and not because the information is particularly informative.

Any particular instance of an XPath is associated with a particular content item displayed to a viewer upon display of the document in which the XPath occurs. For example, FIG. 5 illustrates a graphical representation of HTML page 300 in FIG. 3 generated by a typical web browser. As previously indicated, text nodes 101 and 301 are both represented by the XPath/<HTML>/<body>/<table border, class=“product\_id”, width>/<tr>/<td width>/<#TEXT>. As shown by FIG. 5, the content associated with this XPath in web page 500 is both “This is my text.”, and “This is also my text.” The importance score of an XPath measures the informativeness of the XPath based at least partially on the content associated therewith, i.e., the importance score is high if the XPath is very informative, and the score is low if the XPath is noisy. Thus, the importance of an XPath measures the degree to which the content that the XPath represents is considered noise.

In order to differentiate between informative and noisy XPaths and to assign XPaths differently weighted importance scores accordingly, it is assumed that, in a particular web site, noisy XPaths share common structure and content, while informative XPaths differ in actual content and/or structure. Thus, the importance score of a particular XPath, Xᵢ, is defined in the following Eq. 1:

$$Imp ( {X}_{i} ) = 1 - \frac{{\sum }_{t ∈ T} DF ( {X}_{i} , t )}{N * \vert T \vert} \qquad Eq . 1$$

where t denotes a particular content item; DF(X₁, t) denotes the number of documents containing both Xᵢ and t together; T denotes a set of unique content items associated with XPath, Xᵢ; and N denotes the number of documents in the subject site that have not yet been annotated, which is a subset of the total M pages in the subject site.

Eq. 1 measures the average of the fraction of times each content item, t, is associated with a particular XPath, Xᵢ. Eq. 1 then inverts the average to get the importance score for XPath, Xᵢ. Thus, Eq. 1 assigns a low importance score to Xᵢ if the XPath has common content across pages, i.e., is a noisy XPath. This technique effectively downplays noisy portions of Web pages. Conversely, Eq. 1 assigns a higher importance score to Xᵢ if the XPath has distinct content across the pages of a site because such a diversity of content associated with an XPath indicates that the XPath belongs to an informative region of a document.

### Document Selection

As previously stated, information regarding the XPaths, or structures, of the pages of a site is used to produce representativeness scores for each document in the site. To produce a representativeness score for a document, the information for the document and the site are input into a document ranking formula. The problem of finding representativeness scores for the documents of a site is similar to the problem of ranking documents according to each document's relevance to a given query, as with search engines. Therefore, a formula used to rank documents based on a search query can be modified and used to produce representativeness scores.

The Okapi BM25 measure is one of the popular measures to compute document relevance in the context of query searches. Okapi BM25 is a ranking function based on a probabilistic retrieval framework that is used to rank documents matching a given query according to the relevance of each document to the given query. As with many ranking functions for search queries, the relevance of a document is determined by BM25 using the term frequency of the query terms in the document, the document frequency of the query terms, and the length of the document. In this context, a query term's term frequency (TF) indicates the number of times the query term occurs in a particular document, and a query term's document frequency (DF) indicates the number of documents out of the set of documents being searched that contain the search query. Thus, given a long query Q, containing keywords {q₁, . . . , qₙ}, the BM25 relevance score of a document Dⱼ is determined according to Eq. 2:

$$score ( {D}_{j} , Q ) = {\sum }_{i = 0}^{n} ( log ( \frac{N}{{DF}_{i}} ) * ( \frac{( k 1 + 1 ) * {TF}_{ij}}{\begin{matrix}{TF}_{ij} + ( k 1 * ( ( 1 - b ) + b * ( \frac{{L}_{j}}{{L}_{avg}} ) ) * \\ ( k 3 + 1 ) * \frac{{TF}_{iq}}{k 3 + {TF}_{iq}}\end{matrix}} ) ) \qquad Eq . 2$$

where N denotes the total number of documents in the document collection being queried; DFᵢ denotes the document frequency of the query term qᵢ; TFᵢⱼ denotes the term frequency of query term qᵢ in document Dⱼ; TF_{iq} denotes the term frequency of qᵢ in long query Q, which indicates how many times qᵢ appears in long query Q; Lⱼ denotes the length of document Dⱼ; and L_{avg} denotes the average document length in the document collection being queried.

The term k1 is defined as a tuning parameter (0≦k1≦∞) that calibrates the document term frequency scaling. In other words, adjusting k1 adjusts the importance placed on the quantity of a query term in a document. A k1 value of zero corresponds to a binary model (no term frequency) that detects only the presence of a query term in a document and places no importance on the number of times the query term occurs in the document. A large k1 value corresponds to using raw term frequency, which places a higher weight on documents containing more of the query term. Also, b is defined to be a tuning parameter (0≦b≦1) that determines the scaling of the query term by the length of the particular document. If b=1, then the term weight is fully scaled by document length, and if b=0, then there is no length normalization. Finally, k3 is defined as a tuning parameter that calibrates the term frequency scaling of the query.

The Okapi BM25 works well in an information retrieval framework for computing the relevance score of a document, given a query. For such a formula to correctly compute representativeness scores in the context of the document sampling problem of the embodiments of the invention, some parameters must be changed or removed. In the context of the classic Okapi BM25 measure, the score of a document is inversely proportional to the document frequency of the query term. However, in the context of the embodiments of this invention, the scoring function should consider the representativeness score of a document to be proportional to XPath-DF and XPath-Imp, as opposed to inversely proportional as with the classic BM25. Also, with the classic BM25 measure, the query's term frequency scaling parameter, k3 is required because the long query might contain repeating terms. However, the “query” in the context of the embodiments of this invention consists of all unique XPaths, and the tuning parameter k3 is not required. Thus, the modified BM25 measure to determine the representativeness score of documents in a site is represented in Eq. 3 below:

$$score ( {D}_{j} , XS ) = {\sum }_{i = 0}^{n} ( \begin{matrix}log ( DF ( {X}_{i} ) ) * IMP ( {X}_{i} ) * \\ ( \frac{( k 1 + 1 ) * TF ( {X}_{ij} )}{TF ( {X}_{ij} ) + ( k 1 * ( ( 1 - b ) + b * ( \frac{{L}_{j}}{{L}_{avg}} ) )} )\end{matrix} ) \qquad Eq . 3$$

Eq. 3 receives as input both a particular document Dⱼ to score and the set, XS, of all unique XPaths not in a document already selected for human annotation. Thus, if no documents have been selected for annotation, XS represents the set of all unique XPaths in the subject site comprising the collection of all N documents. Lⱼ denotes the length of document Dⱼ, in terms of the XPaths of the document, i.e., the number of uncovered XPaths present in the document. Also, L_{avg} denotes the average document length of all N documents in term of XPaths, i.e., the average number of uncovered XPaths per document of the site.

As explained with respect to the flowchart of FIG. 4, the representativeness score of a document is based on the set of unique XPaths not already covered in the list of documents selected to be annotated. Thus, when calculating the representativeness scores for the set of documents in the subject site that are not in the list of documents to be annotated, the document length, Lⱼ, is recomputed for each document based on the set of unique uncovered XPaths. Also the average document length, L_{avg}, is recalculated based on the set of unique uncovered XPaths. As such, the embodiments of the passive sampling technique assign the highest representativeness score to the document that is most representative of the structures not present in the documents of set S, thus providing maximum recall with minimum documents to be annotated.

The modified Okapi BM25, as explained, enables a greedy solution to the page sampling problem because the formula calculates the representativeness score for each of a set of documents from a site based on the set of unique XPaths present in the documents, from which the most representative document can be identified by the representativeness scores of the documents, i.e., the highest score. In one embodiment of the invention, if more than one document have the same maximum score, then the tie is broken by selecting the first document with the maximum score. With reference to FIG. 4, the modified BM25 measure is utilized in step 403. However, instead of simply using the page indicated by the representativeness score, as prescribed by the greedy solution to the set-cover problem, the balance of the documents in the site are also inspected to determine which of these documents would add the greatest recall to the recall facilitated by the most representative page. Thus, once the passive sampling technique is completed (FIG. 4, step 410), the result is a list of documents ordered by representativeness scores. The first document of the list is presented to a person for annotations.

### Active Sampling

In one embodiment of the invention, active sampling is used to refine the sample list produced by the embodiments of the passive sampling technique by utilizing information derived from human annotations. For example, the data attributes on an annotated page that are not identified in the human annotations are revealed to be uninteresting. As a further example, the spatial regions of a document that are annotated by humans, or the least common ancestor of the XPaths annotated by humans, are also revealed to be interesting. Also, information on attributes annotated in every human-annotated document from a site can be used to identify trends in the pages of the site. Thus, after each page is annotated by a person, the sample list is actively refined based on the information provided by the annotations.

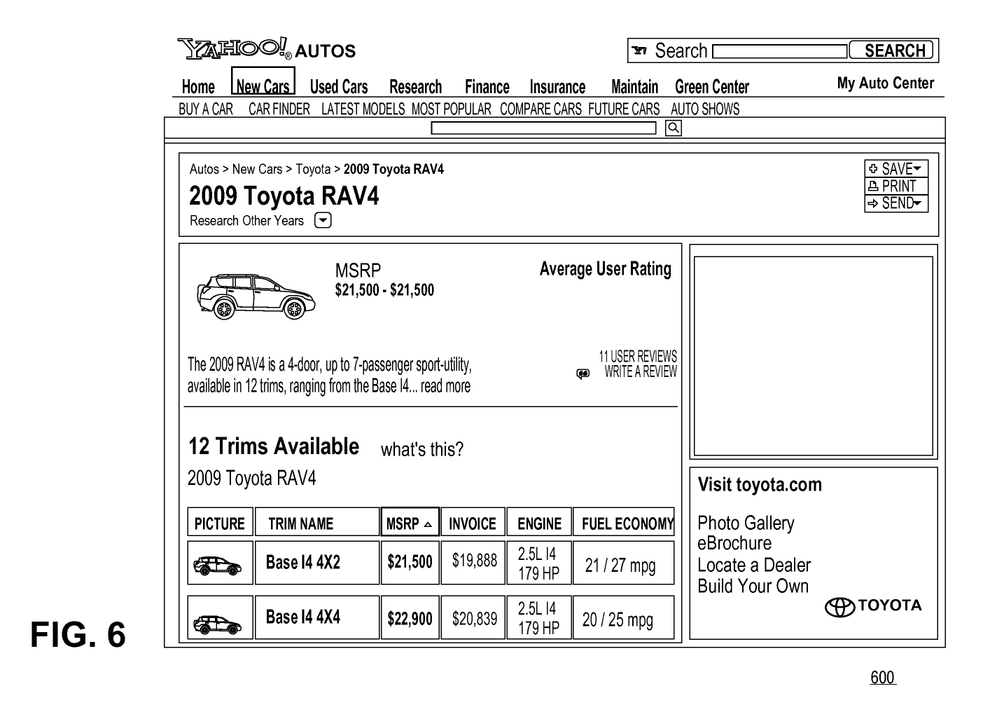

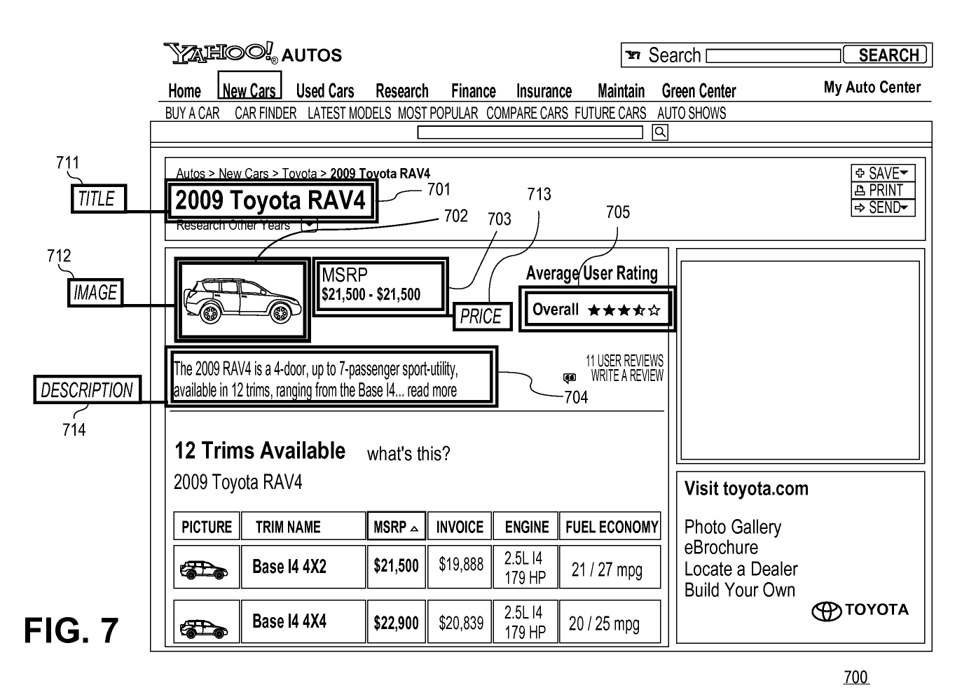

In another embodiment of the invention, information on key attributes derived from human annotations is utilized to refine the list of unique uncovered XPaths used, in the passive sampling technique, to calculate representativeness scores. Human annotations generally consist of identifications of interesting attributes on a page. For example, page 600 in FIG. 6 is an example of a web page from the site “autos.yahoo.com”, and page 700 of FIG. 7 is an example of a human annotation of page 600. A person of skill in the art will understand that annotations of web pages may be accomplished in a variety of ways, and page 700 is presented as a non-limiting example of a human annotation of page 600. The annotations reveal four key attributes on page 700, specifically: title 711 referring to title content 701 on page 700; image 712 referring to image content 702 on page 700; price 713 referring to price content 703 on page 700; and description 714 referring to description content 704 on page 700. Information on page 600 that is not annotated is revealed to be uninteresting, i.e., user ratings 705.

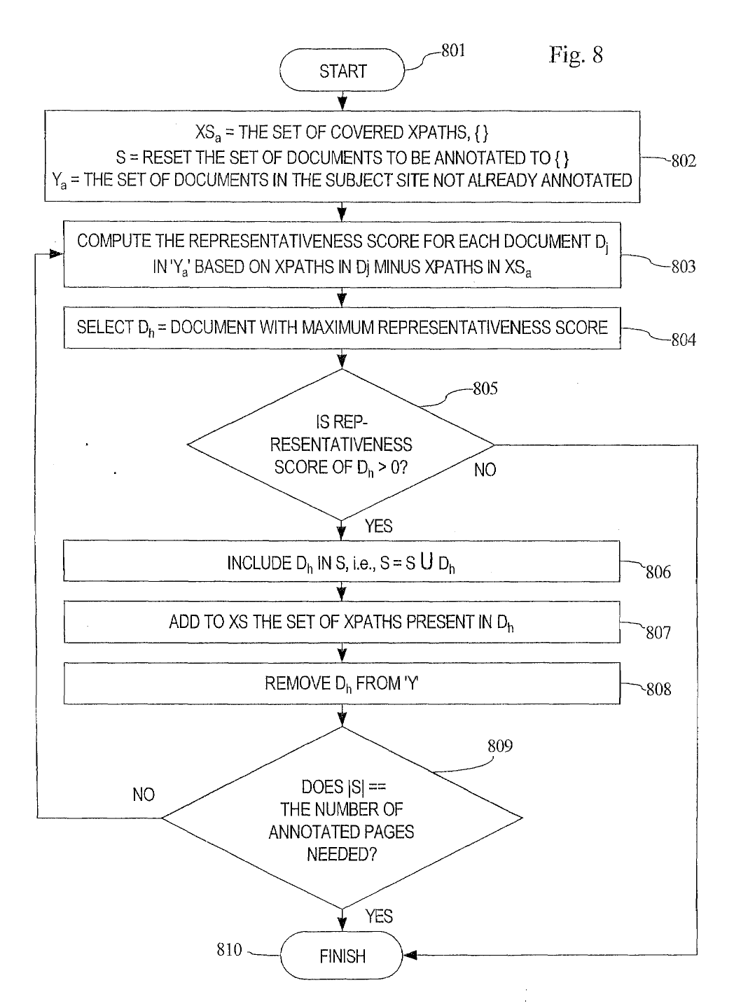

Using this new information, the active sampling technique recalculates the representativeness score for each document in site “autos.yahoo.com” that has not yet been annotated. This recalculation is done according to the passive sampling technique, as illustrated in FIG. 4, with some modifications. These modifications are illustrated in FIG. 8, wherein the set of documents to be annotated, S, is reset to the empty set after an annotated page is received, step 802. XSₐ represents the set of XPaths that occur in the documents in set S, i.e., the set of covered XPaths, and the set of documents in the subject site Yₐ excludes those pages that have already been annotated, also step 802.

In one embodiment of the invention, individual XPaths are identified as uninteresting based on human annotations. If a particular content item in a particular page goes unannotated, and the information for only one product is presented by the page, then the particular item is identified as uninteresting. For example, in the context of the web pages illustrated by pages 600 and 700, page 700 represents only one product, and therefore, user ratings 705 is identified as uninteresting because it was not annotated. Thus, the XPath corresponding to user ratings 705 is removed from consideration when recomputing the representativeness scores of the documents in Yₐ because this attribute 705 is uninteresting. This refinement of the list of XPaths considered in calculating representativeness scores according to the embodiments of the passive sampling technique ensures that the representativeness score of a document is not boosted based on the presence of uninteresting attributes in the document.

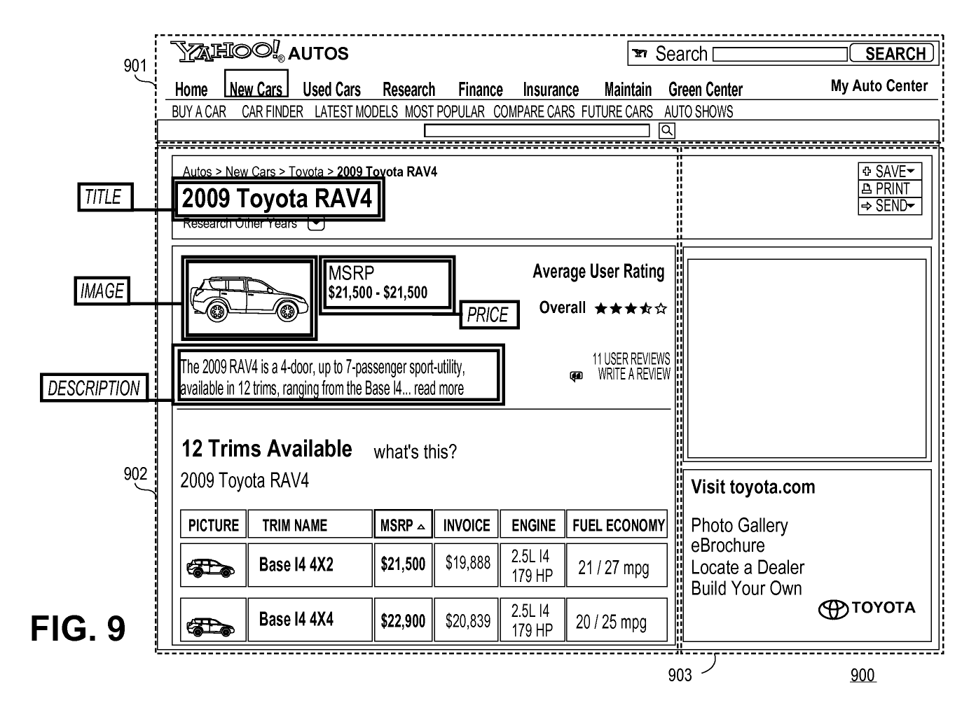

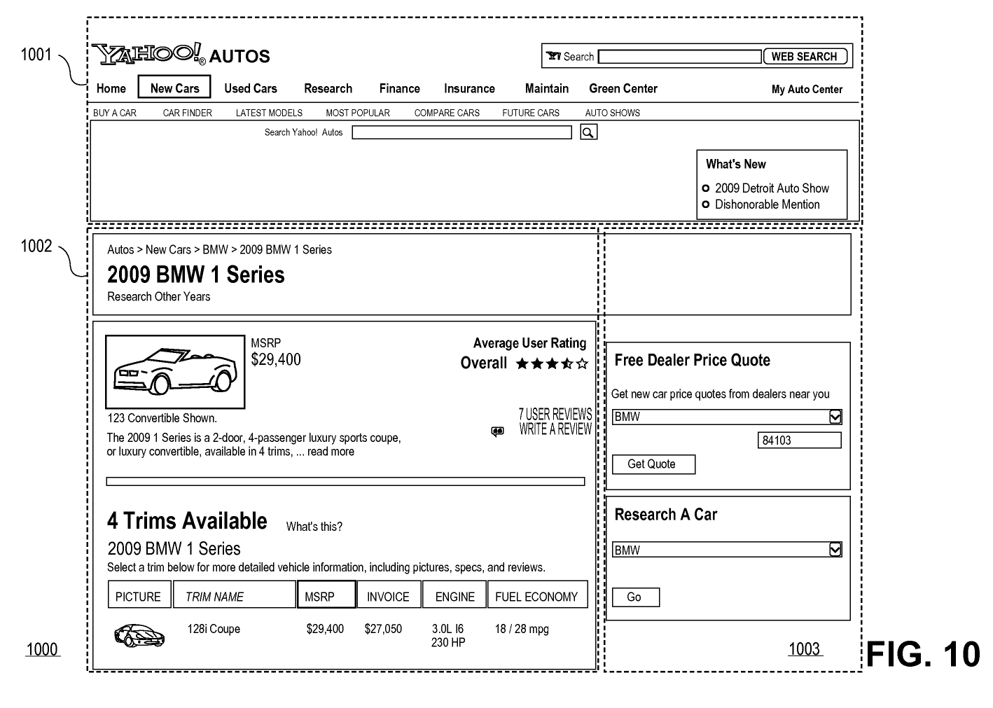

In yet another embodiment of the invention, interesting spatial regions of an annotated document can be identified based on the location of the annotations on the document. For example, annotated page 700 is delineated into spatial regions by an automatic region identifier, as shown on page 900 of FIG. 9, including spatial regions 901-903. For another example, annotated page 700 is delineated into spatial regions by a human. It will be apparent to those of skill in the art that the details of how regions are identified on a page and the exact regions identified may be varied and still be within the scope of the embodiments of this invention. In page 900, annotations are found in region 902, and not in regions 901 and 903. Therefore, region 902 is identified as interesting and regions 901 and 903 are identified as uninteresting.

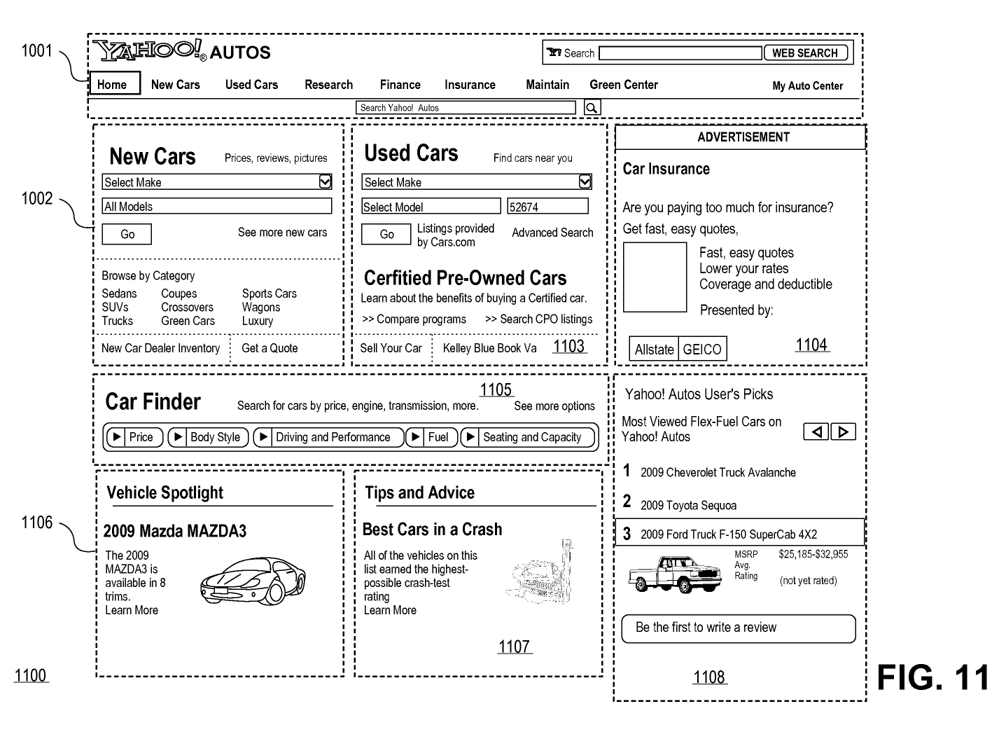

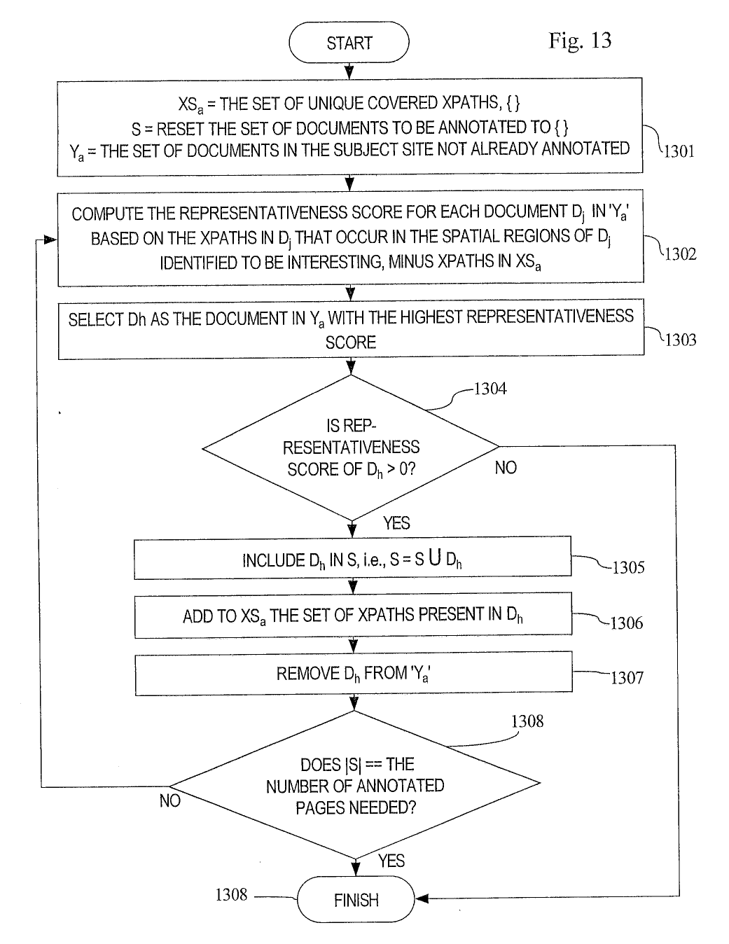

In this embodiment of the invention, active sampling recalculates the representativeness score of each of the unannotated documents in the subject site using the information on interesting spatial regions. Specifically, each document of the set of documents in the subject site that has not yet been annotated is evaluated to identify the spatial regions in the document. If the document, i.e., page 1000 of FIG. 10, contains a spatial region, i.e., region 1002, corresponding to the interesting spatial region of an annotated document, i.e., region 902 of page 900 in FIG. 9, then the representativeness score of page 1000 is based on the XPaths found in interesting spatial region 1002 only. Therefore, in this embodiment of the invention, computation of the representativeness score of each document in Yₐ, as illustrated in step 1302 of FIG. 13, is based on those XPaths found in spatial regions of the document that are identified as interesting.

If a document, i.e., page 1100 of FIG. 11, does not contain spatial regions corresponding to the identified interesting spatial regions, e.g., because the document has structural variations that prevent the identification of such regions, then all of the XPaths in the document will be considered when calculating the representativeness score of the document. Page 1100 has regions 1101-1108, none of which resemble region 902 of page 900. Thus, in this embodiment of the invention, all of the XPaths occurring in page 1100 would be considered when calculating the representativeness score of page 1100, because page 1100 has a different structure than the structure of annotated page 900. After annotating a page such as page 1100, that has a different structure than previously annotated pages, the newly annotated page may identify a different interesting spatial region than the region identified in connection with annotated page 900. In this case, both identified interesting spatial regions are considered in assigning a representativeness score to the unannotated pages of the subject site.

In one embodiment of the invention, a spatial region in an unannotated document is identified as corresponding to an interesting spatial region of an annotated document through the use of Least Common Ancestor (LCA). In this embodiment of the invention, the LCA of XPaths corresponding to annotated attributes is computed. If the LCA of XPaths of the annotated attributes is found in the unannotated document, then the XPaths corresponding to the LCA in the unannotated document are considered to be in an interesting spatial region. In another embodiment of the invention, visual information about an annotated spatial region is gathered, i.e., x- and y-coordinates, height, width, etc., and an unannotated document is searched to determine if the document has a corresponding spatial region based on the gathered visual information and annotated XPaths.

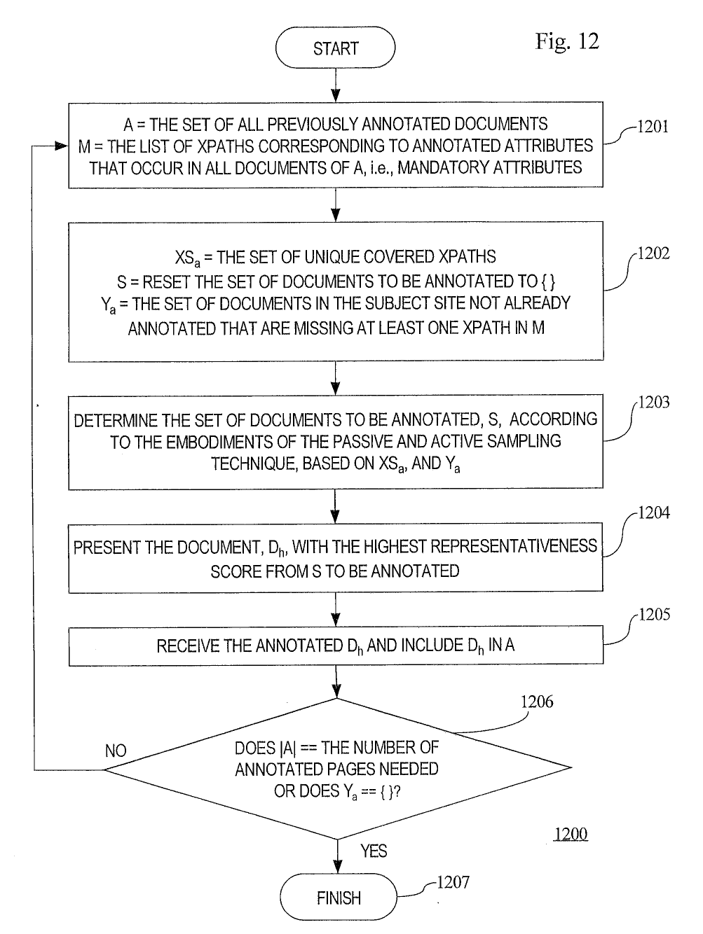

Another embodiment of the invention identifies mandatory attributes among the pages of a site and makes decisions of whether to include a particular page in the list of sample pages to be annotated based on the known mandatory attributes, as illustrated by FIG. 12. In this embodiment, mandatory attributes are defined to be all of the attributes that have been identified in each of the pages that have been annotated for a site, step 1201. For example, if only one page has been annotated, and the attributes title, description, image, and price were found in the page, then title, description, image, and price are the mandatory attributes for the site because these attributes have been in all (one) of the pages that have been annotated. If another page is then annotated and has the attributes title, description, and price, but not image, then the mandatory attributes of the site are revised to be title, description, and price, but not image. The image attribute is removed from the list of mandatory attributes because image is not found in all of the annotated pages in the site.

In this embodiment of the invention, those documents that contain all of the XPaths corresponding to the identified mandatory key attributes are removed from the list of sample documents to be annotated because it is likely that nothing more can be learned from documents with all of the mandatory attributes. However, if a document is apparently missing an XPath for a mandatory attribute, then the document is surfaced for human annotation because a missing mandatory attribute is indicative of an unknown structural variation having to do with the missing mandatory attribute. Annotating such a document will likely add to what is known about the structure of the site, especially with respect to the missing mandatory attribute. Therefore, in step 1202 of FIG. 12, the set of documents from which sample documents will be selected includes only those documents missing at least one mandatory XPath. The ordered list of documents is determined according to the embodiments of the invention, step 1203. The document with the highest representativeness score from the ordered list is presented for annotation, step 1204, and the annotated document is included in the list of all previously annotated documents, step 1205. In step 1206, if no more annotated documents are needed, i.e., because the number of documents previously annotated is sufficient or because all documents in the subject site have been annotated, then the process 1200 finishes, step 1207. In contrast, if more annotated documents are needed at step 1206, then the list of mandatory attributes is recomputed and another sample document is selected.

With respect to identification of interesting spatial regions, the computation of representativeness scores is restricted to XPaths in the spatial regions identified to be interesting. Thus, if a particular document has one or more spatial regions identified as interesting, then mandatory attributes are only sought in those interesting spatial regions. If the interesting spatial regions of a document do not contain the XPath of each mandatory attribute identified for the site, and the document has additional XPaths occurring inside of the interesting spatial regions, then the document is considered to have a mandatory attribute with a different XPath than the XPath that has been previously identified as associated with the missing mandatory attribute. Such documents are scored using active sampling technique and the document with highest score is surfaced to human for annotation.

For active sampling to be effective, the first document selected by the embodiments of the passive sampling technique ideally covers the majority of the key attributes in the subject site because the embodiments of the active sampling technique consider annotated attributes to refine the sample list. If the pages being annotated are not in order of representativeness, then active sampling may detrimentally ignore regions of a document that contain interesting information.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

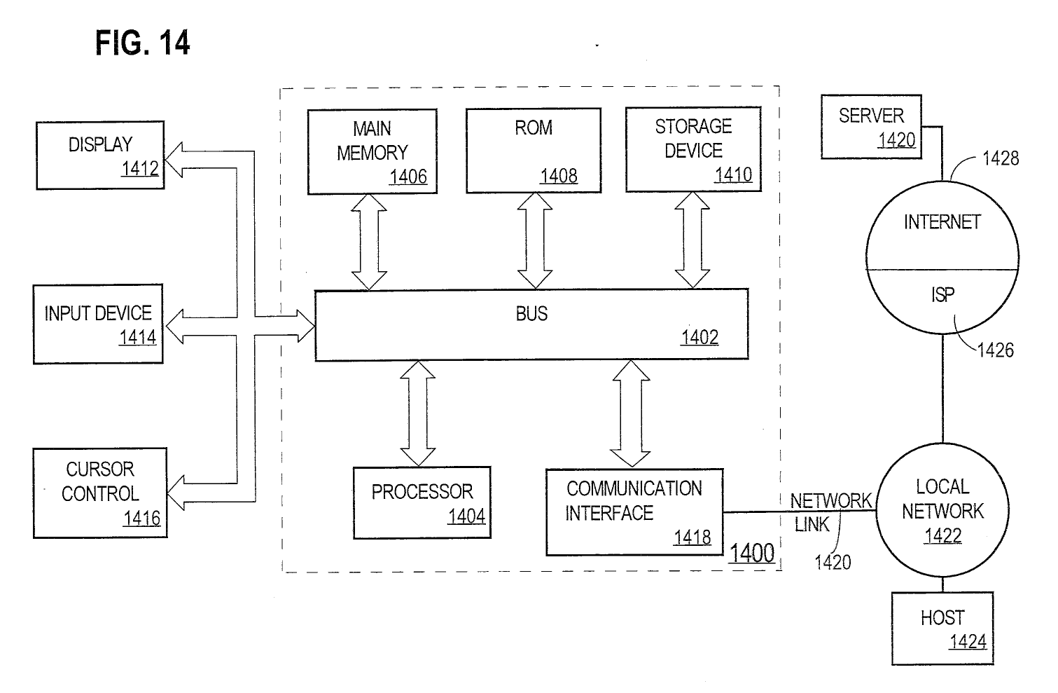

For example, FIG. 14 is a block diagram that illustrates a computer system 1400 upon which an embodiment of the invention may be implemented. Computer system 1400 includes a bus 1402 or other communication mechanism for communicating information, and a hardware processor 1404 coupled with bus 1402 for processing information. Hardware processor 1404 may be, for example, a general purpose microprocessor.

Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, such as a magnetic disk or optical disk, is provided and coupled to bus 1402 for storing information and instructions.

Computer system 1400 may be coupled via bus 1402 to a display 1412, such as a cathode ray tube (CRT), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane.

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 1410. Volatile media includes dynamic memory, such as main memory 1406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world wide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-executed method comprising:
determining a first set of paths in a first set of documents;
determining a set of respective sets of paths corresponding to each document of a second set of documents;
wherein the respective set of paths corresponding to a particular document of the second set of documents comprises paths occurring in the particular document and excludes paths in the first set of paths;
determining a representativeness score for each document of the second set of documents;
wherein determining a representativeness score for a particular document of the second set of documents is based at least in part on the respective set of paths corresponding to the particular document;
selecting, from the second set of documents, a first document having a highest representativeness score of the second set of documents;
including the first document in the first set of documents;
after including the first document in the first set of documents, selecting, from the first set of documents, a second document having a highest representativeness score of the first set of documents; and
presenting the second document to a person;
wherein the method is performed by one or more computing devices programmed to be special purpose machines pursuant to program instructions.

2. The computer-executed method of claim 1, wherein computing the representativeness score for each of the first set of documents comprises:
selecting a particular document of the second set of documents;
determining a term frequency score based at least in part on a number of times a particular path occurs in the particular document;
determining a document frequency score based at least in part on a number of documents of the first set of documents in which the particular path occurs;
determining an importance score based at least in part on a measure of a fraction of times that the particular path represents a particular content item in the first set of documents; and
calculating a representativeness score for the particular document based at least in part on the term frequency score, the document frequency score, and the importance score.

3. The computer-executed method of claim 2, wherein determining an importance score further comprises:
determining a set of content items, wherein each content item of the set of content items is associated with the particular path in at least one document of the second set of documents;
determining a set of fractions, wherein each fraction of the set of fractions represents a number of documents in which a particular content item of the set of content items is associated with the particular path divided by a total number of documents in the second set of documents;
determining an average of the set of fractions;
inverting the average of the set of fractions to obtain an inverted average; and
basing the importance score at least in part on the inverted average.

4. The computer-executed method of claim 2, wherein calculating a representativeness score for the particular document further comprises:
modifying an Okapi BM25 measure to compute the representativeness score as proportional to the document frequency score and to the importance score; and
calculating, by the modified BM25 measure, the representativeness score.

5. The computer-executed method of claim 1, wherein a path comprises an XPath (a) comprising a set of nodes, and (b) optionally comprising at least one of:
an attribute list for a particular node of the set of nodes; and
a value of a class attribute present in the attribute list.

6. The computer-executed method of claim 1, further comprising:
including, in the first set of paths, the respective set of paths corresponding to the first document;
removing the first document from the second set of documents to create a third set of documents;
determining a representativeness score for each document of the third set of documents;
selecting, from the third set of documents, a third document having a highest representativeness score of the third set of documents; and
including the third document in the first set of documents.

7. The computer-executed method of claim 1, further comprising:
receiving a set of annotations of the second document;
identifying a set of spatial regions of the second document;
identifying a first subset of regions of the first set of spatial regions, wherein each region of the first subset of regions contains an annotation of the set of annotations;
identifying a second set of spatial regions of a third document, including a second subset of regions corresponding to the first subset of regions;
determining a second set of paths comprising paths occurring in the second subset of regions less paths included in the first set of paths; and
calculating a representativeness score for the third document based on the second set of paths.

8. The computer-executed method of claim 1, further comprising:
receiving a first set of annotations for the second document comprising identifications of attributes in the second document;
presenting a third document for annotation;
receiving a second set of annotations for the third document comprising identifications of attributes in the third document;
determining a set of mandatory attributes comprising the set of all attributes identified in both the first set of annotations and the second set of annotations;
removing from the first set of documents a fourth document containing a path corresponding to each attribute of the set of mandatory attributes; and
presenting for annotation a fifth document that does not contain a particular path of the paths corresponding to each attribute of the set of mandatory attributes.

9. The computer-executed method of claim 1, wherein the first set of documents and the second set of documents are mutually exclusive.

10. One or more storage media storing instructions which, when executed by one or more computing devices, cause performance of the method recited in claim 1.

11. One or more storage media storing instructions which, when executed by one or more computing devices, cause performance of the method recited in claim 2.

12. One or more storage media storing instructions which, when executed by one or more computing devices, cause performance of the method recited in claim 3.

13. One or more storage media storing instructions which, when executed by one or more computing devices, cause performance of the method recited in claim 4.

14. One or more storage media storing instructions which, when executed by one or more computing devices, cause performance of the method recited in claim 5.

15. One or more storage media storing instructions which, when executed by one or more computing devices, cause performance of the method recited in claim 6.

16. One or more storage media storing instructions which, when executed by one or more computing devices, cause performance of the method recited in claim 7.

17. One or more storage media storing instructions which, when executed by one or more computing devices, cause performance of the method recited in claim 8.

18. One or more storage media storing instructions which, when executed by one or more computing devices, cause performance of the method recited in claim 9.
